(19) United States
(12) Patent Application Publication
(10) Pub. No.: US 2008/0070055 A1
(43) Pub. Date: Mar. 20, 2008

(54) ADHESIVE DECORATIVE PAPER AND METHOD FOR MANUFACTURING SAME

(76) Inventor: CHARLES L. KING, BOISE, ID (US)

Correspondence Address: DYKAS, SHAVER & NIPPER, LLP, P.O. BOX 877, BOISE, ID, 83701-0877, US

(21) Appl. No.: 11/532,775

(22) Filed: Sep. 18, 2006

(51) Int. Cl. B32B 27/10; B05D 5/10; B05D 1/36

(52) U.S. Cl. 428/514; 427/402; 427/207.1

(57) ABSTRACT

An aesthetically pleasing and weather resistant coating for application to surfaces such as signs. This material may be applied directly to a surface or applied through the application of precut pieces. The pieces including a multi-part paper that includes an adhesive layer and an upper surface. An acrylic polymer layer having designated qualities covers the upper surface, which is then covered in a glitter made from precut metalized film particles. This is then covered with a protective weather resistant clear coat. Depending upon the exact circumstances in which this material is to be used, the particular configuration of the device can be varied.

### FIELD OF THE INVENTION

The present invention generally relates to craft and sign making and more particularly to the creation of decorative materials and coatings which are used in these arts.

### BACKGROUND OF THE INVENTION

In order to protect and provide an aesthetically pleasing appearance to an object a variety of methods and devices are utilized. Painting is one of these methods. Painting an object can provide a covering to the object that imparts a variety of protective and aesthetic benefits. Paint may be provided to impart desired characteristics such as rust prevention, corrosion inhibition and weather proofness to the material. In addition, it may be utilized to enhance the physical properties and functions of the material as well as to improve the surface hardness and provide heat resistance, electric insulation or electro conductivity to the particular item. The decorative effect that can be provided by painting allows a desired quality related to the color, texture, reflectivity or appearance of a coating membrane of paint to be imparted to the underlying object. In addition to painting, a variety of other types of methods may also be utilized to provide a desired type of covering to a device.

However, items that are painted or otherwise decorated may also have their outer decorative appearance marred or altered by the impact of sun, wind, rain, or other elements. In addition there are some surface finishes that simply do not allow or provide for the designated characteristics which have been placed upon a device to remain in place and in position for a designated period of time. Furthermore, paints are not always capable of providing a desired aesthetic effect because of inherent features of the paint or application itself or because of various modifications that are required but cannot be achieved because of various other limitations.

It is an object, therefore, of the present invention to provide a surface coating that can be placed upon a designated surface and which can be utilized to provide an aesthetically pleasing surface. It is a further object of the invention to provide a material that can be placed upon a surface which is resistant to the wear and damage that can be incurred upon such a device by elements such as sun, wind, and weather. Furthermore it is an object of the present invention to disclose a method for producing such a coating material and providing an easy method for placing such a material upon a device.

### SUMMARY OF THE INVENTION

The present invention is a coating and a method for making and applying a coating to articles such as signs and other similar devices. The invention is made up of a multi-part paper that includes an adhesive layer. This adhesive layer is bonded to an upper surface layer, which serves as a platform upon which the coating of the instant invention can be applied. An acrylic polymer layer covers the upper surface, preferably this layer of polymer has a high solids content and also contains a variety and number of designated quantities of protective materials including mildewcides, fungicides, and UV protective materials. This polymer layer may be tinted or otherwise colored to provide a desired aesthetically pleasing appearance. Depending upon the exact circumstances in which this material is to be used, the particular configuration of the device may be varied.

A glitter coating then covers the adhesive layer. This glitter is made in a variety of shapes, colors and images, these include but are not limited to iridescent colors, aluminized colors, polyester colors, florescent colors and holographic colors. Preferably, the glitter is made so as to have zero flammability and zero chemical reactivity.

In some embodiments of the invention, a clear coat layer covers this layer of glitter. In the preferred embodiment, this clear coat is a layer of acrylic water repellent transparent sealer, which is applied to a thickness roughly equal to the thickness of the glitter layer over which this clear coat layer is placed.

Once this material has been set, the paper which has been formed in such a process may be cut according to the needs of a particular user and placed in a designated area. This invention is particularly useful to persons such as sign makers who are able to, through this process, create signs that are significantly more apparent and eye catching than other typical lettering which may exist. This present invention produces a sign that provides eye-catching appeal, reduced maintenance, increased resistivity to natural forces and decreased over costs to a sign owner as compared to other devices. In addition to the application of the present material to signs the present invention may also be utilized to provide these same advantages to a variety of consumers in a variety of different embodiments.

In addition to the embodiment of the present invention as an adhesive paper, the present invention may also be applied directly to a surface so as to produce a surface with the features, which have been designated by the present invention.

While the preferred embodiment of the invention has been set forth as being particularly related to lettering for signs, it is to be distinctly understood that the invention is not limited thereto, but may be various embodied and utilized in a variety of applications and circumstances, including but not limited to scrap booking, arts and crafts projects, sign making, construction marking, surveying, trail marking, auto mobile and home decorating, detailing and customization.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a top perspective view of the present invention, in a peeled back embodiment so as to show the various levels of the paper in the preferred embodiment.

FIG. 2 is a flow chart indicating the method of applying the coating of the present invention in a preferred embodiment of the invention.

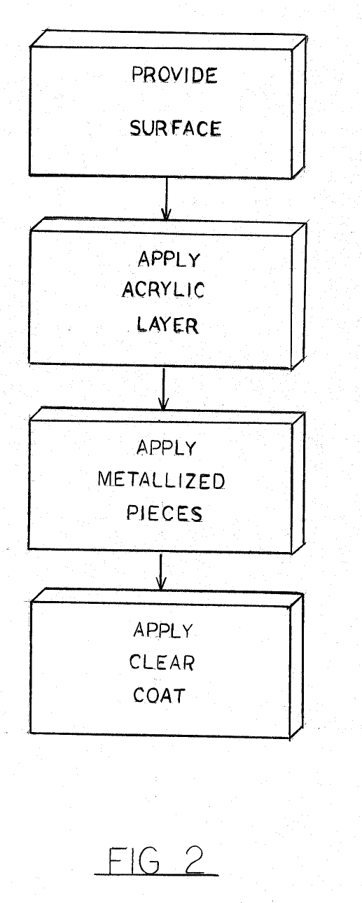

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description and in the figures, like elements are identified with like reference numerals. The use of “or” indicates a non-exclusive alternative without limitation unless otherwise noted. The use of “including” means “including, but not limited to,” unless otherwise noted.

The present invention is a decorative paper that includes a coating that can be produced, applied and placed upon a surface so as to provide a pleasing aesthetic effect. This invention also provides a surface that is resistant to fading, mildew, rot, water damage and does not, under typical circumstances, require repainting or surface modifications as many prior art devices require. While the present invention is described as being utilized in conjunction with a piece of paper, it is to be distinctly understood that the invention is not limited thereto but may be variously configured and utilized upon a variety of surfaces without removing or altering any of the outlined and designated features of the present invention.

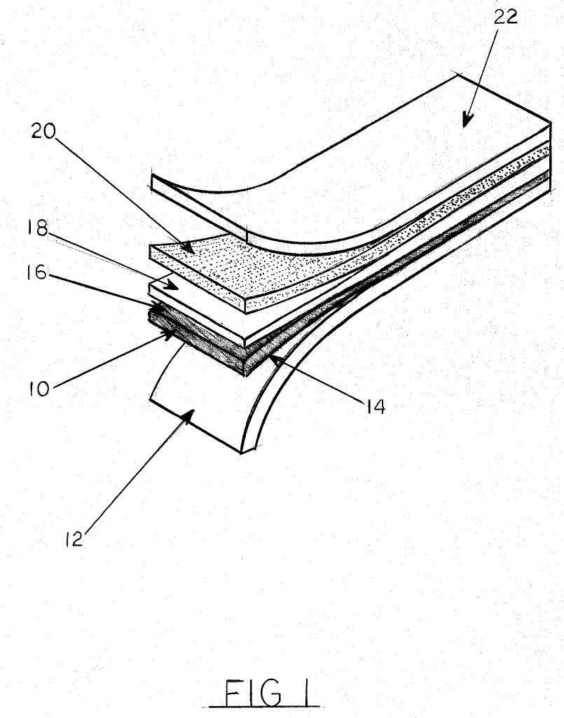

FIG. 1 shows a top perspective view of one embodiment of the present invention wherein the various layers of the material are shown. In this embodiment the present invention is embodied upon a piece of paper. While this particular embodiment of the invention is shown, it is to be distinctly understood that the invention is not limited thereto but may be variously embodied to incorporate a variety of other instances and devices.

In this preferred embodiment, the invention is applied to a multi-part paper 10 that includes a lower film 12 that covers an adhesive layer 14. This adhesive layer 14 is bonded to an upper surface layer 16, which serves as a platform upon which the coating of the instant invention can be applied. Preferably these layers 12, and 16 are made from synthetic materials so as to allow for increased resistance to natural elements such as wind, water, temperature fluctuations and the like. The film layer 12 is bonded to the adhesive layer 14 and provides protection for the adhesive 14 and the upper surface layer 16 until this film 12 is removed. This adhesive which is located upon the adhesive layer 14 is bonded to the back of the upper surface layer 16 so as to allow the application of this paper 10 to other surfaces.

In the preferred embodiment, this paper is made up of the lower film 12, the adhesive layer 14 and the upper surface 16. An example of a preferred type of such a paper is sold under the trade name Squeeze-Film Face Sheet™ by the Print O Tape Corporation.

An acrylic polymer layer 18 covers the upper surface 16. Preferably, this layer of polymer is approximately 2 millimeters thick, and is made up of an acrylic polymer that has a high solids content and which also contains a variety and number of designated quantities of protective materials including mildewcides, fungicides, and UV protective materials. Preferably this is applied by a high-pressure spray attachment which allows the deposition of this material to take place in a quick and effective manner. This method of application also provides a seamless coating upon the film. Preferably this coating is also non-toxic and water based. This polymer may be tinted or otherwise colored to provide a desired aesthetically pleasing appearance. Depending upon the exact circumstances in which this material is to be used, the particular configuration of the device may be varied. Depending upon the exact necessities of the user, various colors of this acrylic high solids polymer may be utilized. In some embodiments of this invention with this high solids coating, it may be applied directly to metal, wood, concrete and plastic substrates. In the preferred embodiment of the invention this coating is a product sold under the trade name ENERGY GUARD™ by Lexis Coatings LLC.

A glitter coating then covers the adhesive and in the preferred embodiment of the invention has a thickness of approximately 1 mm. This glitter coating is made up of pieces of precision cut metalized film particles that are made up of polyethylene tetrephalate, aluminum and other ingredients. This glitter is made in a variety of shapes colors and images; these include but are not limited to iridescent colors, aluminized colors, polyester colors, florescent colors and holographic colors. Preferably, the glitter is made so as to have zero flammability and zero chemical reactivity. In the preferred embodiment of the invention the glitter is manufactured by a company called Meadow Brook Inventions LLC and is sold under the trade name polyester Jewels. In addition to this particular type of glitter, the invention may also utilize other types of glitter material and the examples cited herein are to be interpreted as illustrative only and not as limiting in any manner.

In the preferred embodiment of the invention, which is set forth in FIG. 1 of the application, a clear coat layer 22 covers this layer of glitter 20. In the preferred embodiment, this clear coat 22 is a layer of acrylic water repellent transparent sealer which is applied to a thickness roughly equal to the thickness of the glitter layer over which this clear coat layer is placed. In the preferred embodiment of the invention, this layer is made by depositing such a material sold under the trade name White Roc, by Dequesse Building Systems upon the glitter until this material has a thickness approximately equal to the thickness of the glitter which is covered.

Once this material has been set the paper which has been formed in such a process may be cut according to the needs of a particular user and placed in a designated area. This invention is particularly useful to persons such as sign makers who are able to, through this process, create signs that are significantly more apparent and eye catching than other typical lettering which may exist. This present invention produces a sign that provides eye-catching appeal, reduced maintenance, increased resistivity to natural forces and decreased over costs to a sign owner as compared to other devices. In addition to the application of the present material to signs, the present invention also may be utilized to provide these same advantages to a variety of consumers in a variety of different embodiments.

In addition to the embodiment of the present invention as an adhesive paper, the present invention may also be applied directly to a surface so as to produce a surface with the features which have been designated by the present invention.

The application of the present invention begins with providing a surface upon which the materials that make up the present invention may be applied. In the preferred embodiment of the invention this typically includes providing a clean dry surface upon which the present invention may be utilized. A layer of acrylic adhesive with high solids is first applied to this surface. As has been described previously, this acrylic adhesive is preferably non-toxic and VOC complaint and contains mildewcides, fungicides, and provides excellent UV protection. This layer may be provided with various colors and tints including the inclusion of various holographic colors and patterns so as to provide a desired appearance.

Over this coating a layer of glitter is placed. The type of glitter that is utilized varies. However, in the preferred embodiment of the invention the glitter is sold under the trade name POLYESTER JEWELS™. This material is typically made up of precision cut metallized film particles made from polyethylene terepthalate and aluminum, other materials may also be added to this mixture. This glitter is preferably non-chemically reactive and can be cut in various shapes, patterns and colors; these include iridescent colors, aluminized colors, polyester colors, florescent colors, and holographic colors.

On top of this glitter coating a clear coat can then be placed. This clear coat is preferably a water and UV resistant acrylic clear coat sealer. In the preferred embodiment of the invention this sealer is sold under the trade name WHITE ROC. This clear coat protects the glitter against damage from sun and water, but yet is sufficiently permeable so as to allow the underlying material to breathe and release water out from underneath this layer.

In the preferred embodiment of the invention, this material is applied by placing the film paper upon a surface such as an application table and securing the sides of the paper so as to ensure that this paper will not move. The acrylic high solids material is then applied to the paper to a thickness of approximately 2 mm. The glitter is then applied over this acrylic coating to a thickness of about 1 mm. After this combination has dried, the acrylic clear coating may be sprayed over this device. The application of this clear coating is especially important in circumstances where climate problems such as salt water, sun, snow or rain are likely.

This paper can then be put in various shapes by persons such as sign designers who will utilize figures cut from this material to cut and form letters which can be placed upon a sign by simply removing the backing from the adhesive film paper and applying this paper to a particular device. The present invention can be utilized upon a variety of surfaces including concrete, metal, wood and plastic. While the preferred embodiment of the invention has been set forth as being particularly related to lettering for signs it is to be distinctly understood that the invention is not limited thereto but may be various embodied and utilized in a variety of applications and circumstances, including but not limited to scrap booking, arts and crafts projects, sign making, construction marking, surveying, trail marking, auto mobile and home decorating, and detailing and customization.

In other circumstances the present invention may be utilized as an application method directly to the underlying substrate without the use of the film carrier to transport the coating from one location to another. In such an embodiment the acrylic high solids polymer can be sprayed directly upon a surface such as metal, wood, concrete or other device. The glitter can then be directly placed or sprayed on top of this coating and the clear coat then sprayed over the glitter. The inclusion of this clear coat and the thickness of this clear coat depend upon a variety of factors including the location and circumstance in which the material is to be placed.

The exemplary embodiments shown in the figures and described above illustrate but do not limit the invention. It should be understood that there is no intention to limit the invention to the specific form disclosed; rather, the invention is to cover all modifications, alternative constructions, and equivalents falling within the spirit and scope of the invention as defined in the claims. For example, while the exemplary embodiments illustrate sign making, the invention is not limited to use with sign making and may be used with other arts as well. Hence, the foregoing description should not be construed to limit the scope of the invention, which is defined in the following claims.

What is claimed is:

1. An adhesive coated decorative paper comprised of:
a base paper having a first layer and a second layer, said first layer having an application surface coated with an adhesive material;
an acrylic polymer with high solids positioned over said base paper, said acrylic polymer including at least one fungicide, at least one mildewcide and a UV blocking material; and
a layer of precision cut metallized film particles placed over said acrylic polymer.

2. The decorative paper of claim 1 further comprising a clear coat covering which covers said base paper, said acrylic polymer and said precision cut metalized film particles.

3. A decorative covering comprised of:
an acrylic polymer with a high solids ratio, applied to an object;
a layer of precision cut metalized film particles placed over said acrylic polymer.

4. The decorative covering of claim 3 further comprising a clear coating covering which covers said layer of precision cut metal particles.

5. The decorative covering of claim 3 wherein said acrylic polymer is tinted.

6. The decorative covering of claim 3 wherein said polymer includes at least one fungicide.

7. The decorative covering of claim 3 wherein said polymer includes a UV resisting substance.

8. The decorative covering of claim 3 wherein said polymer includes a mildewcide.

9. The decorative covering of claim 3 wherein said polymer includes at least one mildewcide, at least one fungicide, and at least one UV resisting substance.

10. The decorative covering of claim 3 wherein said metalized film particles are holographic.

11. A method for making an adhesive coated decorative paper comprised of, a synthetic multi-layer paper having a first layer and a second layer, said first layer having an application surface coated with an adhesive material, an acrylic polymer with high solids positioned on said synthetic multilayer paper, said acrylic polymer including at least one fungicide, at least one mildewcide, and a UV blocking material; and a layer of precision cut metallized film particles placed over said acrylic polymer; said method comprising the steps of:
providing a synthetic multi-layer paper having a first layer and a second layer, said first layer having an application surface coated with an adhesive material;
applying a coating of an acrylic polymer having a high solids content over said synthetic multi-layer paper, said acrylic polymer including at least one fungicide, at least one mildewcide and a UV blocking material; and
applying a layer of precision cut metalized film particles over said acrylic polymer, whereby said precision cut metalized film particles become stuck to and embedded within said acrylic polymer,

12. The method of claim 11 further comprising the steps of applying a clear coating over said multilayer paper.

13. The method of claim 12 where in said polymer is sprayed over said synthetic multilayer paper.

14. The method of claim 12 wherein said polymer is tinted.
